(19) United States
(12) Patent Application Publication
(10) Pub. No.: US 2019/0331399 A1
(43) Pub. Date: Oct. 31, 2019

(54) HINGE ASSEMBLY AND REFRIGERATOR HAVING SAME

(71) Applicant: Daewoo Electronics Co., Ltd., Gwangju (KR)

(72) Inventor: Hyeong-Doo JEONG, Gwangju (KR)

(21) Appl. No.: 16/223,663

(22) Filed: Dec. 18, 2018

(30) Foreign Application Priority Data
Apr. 30, 2018 (KR) 10-2018- 0049722

(51) Int. Cl. F25D 23/02; E05D 7/04

(52) U.S. Cl. CPC F25D 23/028; F25D 2323/024; E05D 7/04

(57) ABSTRACT

The present invention relates generally to a hinge assembly and refrigerator having the same. More particularly, the present invention relates to a hinge assembly and refrigerator having the same, in which the thickness of the hinge assembly is increased in the up and down direction compared to the conventional hinge structure to significantly increase the resistance to a continuous load, whereby it is possible to guarantee a sealing force above a predetermined level even in long-term use of the refrigerator.

### CROSS REFERENCE TO RELATED APPLICATION

The present application claims priority to Korean Patent Application No. 10-2018-0049722, filed Apr. 30, 2018, the entire contents of which is incorporated herein for all purposes by this reference.

### BACKGROUND OF THE INVENTION

### Field of the Invention

The present invention relates generally to a hinge assembly and a refrigerator having the same. More particularly, the embodiments of the present invention relate to a hinge assembly and a refrigerator having the same, in which the hinge assembly has improved sealing effectiveness for the refrigerator.

### Description of the Related Art

A refrigerator is an appliance that maintains its contents, such as food items, in a fresh condition for a long time through cold air supplied to an internal compartment, where the cold air is generated by heat exchange of a refrigerant that undergoes a refrigeration cycle.

Generally, the refrigerator includes a main body 91 in which an internal storage chamber is formed, and a door unit 93 for selectively opening and closing a front side of the main body 91. Further, the door unit 93 is rotated with respect to the main body 91 to selectively open and close the storage compartment. Thus, the door unit 93 is generally hinged to the front surface of the main body 91.

FIG. 1 is a reference view showing a refrigerator to which a conventional hinge structure is coupled; and FIG. 2 is an enlarged view showing the hinge structure of FIG. 1.

Hereinbelow, reference will be made in detail to a hinge structure 95 for a conventional refrigerator.

Referring to FIGS. 1 and 2, the hinge structure 95 for the conventional refrigerator includes: a mounting plate 951 disposed on the a side of the front surface of the main body 91; and a thin planar supporting plate 953 protruding forward from the mounting plate 951 and inserted into a space between the upper and lower door units 93. Further, the supporting plate 953 includes a coupling member 955 extending downward and having a vertical hollow portion therein. Thus, a coupling means is inserted into the hollow portion of the coupling member 955, which serves as the rotation shaft of the door unit 93.

There are problems associated with the conventional hinge structure 95. Namely, when the door unit 93 is opened, the supporting plate 953 and the coupling member 955 receive the weight of the door unit 93 which is placed at the upper portion of the hinge structure 95. Accordingly, when the refrigerator 9 is used for a long time, downward deflection occurs in the supporting plate 953, which unfortunately causes the door unit 93 to separate downward from its original position and eventually the door will not align with the front of the main body 91 when the door unit 93 is closed. This misalignment leads a sealing problem in the sealing force and effectiveness of the refrigerator 9.

Further, since the mounting plate 951 and the connecting portion of the mounting plate 951 and the supporting plate 953 protrude from the front of the refrigerator 9 toward the user, this configuration may lead to potential injury accidents.

To solve the above-described problems, embodiments of the present invention disclose a hinge assembly and refrigerator having the same, in which the sealing effectiveness is improved and the possibility of potential injury accidents, as described above, are reduced.

The foregoing is intended merely to aid in the understanding of the background of the present invention, and is not intended to mean that the present invention falls within the purview of the related art that is already known to those skilled in the art.

### SUMMARY OF THE INVENTION

Accordingly embodiments of the present invention include hinge assembly (and refrigerator having same) in which by significantly increasing the resistance to a continuous load, it is possible to guarantee the sealing force of the appliance above a predetermined level, even in long-term use of the refrigerator, and also possible to prevent or reduce potential injury accidents associated with the hinge. Accordingly, it is an object of the present invention to provide a hinge assembly and refrigerator having the same, in which the entire thickness of the hinge assembly is increased and where the hinge assembly functions to guide rotation of a rotatable opening and closing unit (e.g., door). This configuration thereby improves resistance to a vertical load asserted by the weight of the rotatable opening and closing unit.

Further, it is a second object of the present invention to provide a hinge assembly and refrigerator having the same, in which by improving the vertical load resistance of the hinge assembly to prevent deflection of the rotatable opening and closing unit, it is possible to improve the sealing force of the refrigerator.

Further, it is a third object of the present invention to provide a hinge assembly and refrigerator having the same, in which the hinge assembly is disposed on the inner surface of the refrigerator and is not coupled to the front and the rear surfaces of the rotatable opening and closing unit or the body unit so as not to protrude toward a user, thereby preventing potential injury accidents.

In order to accomplish the objects of the present invention as described above and to carry out the characteristic functions of the present invention described below, embodiments of the present invention are described as follows.

According to an embodiment of the present invention, a refrigerator having a hinge assembly includes: a body unit forming an overall appearance of the refrigerator and being configured such that an inner space thereof is recessed from a front side to a rear side to form a storage compartment or chamber; a rotatable opening and closing unit coupled to the front side of the body unit to selectively and rotatably open and close the storage compartment; and a hinge assembly having a first side thereof coupled to the body unit and a second side thereof coupled to the rotatable opening and closing unit, the hinge assembly operable to allow the rotatable opening and closing unit to rotate, and wherein the hinge assembly includes: a first body member extending in a vertical direction and being fixed to an inner surface of the body unit; a second body member extending in the vertical direction and being fixed to an inner surface of the rotatable opening and closing unit; and first and second support members coupled to the first and second body members respectively, and configured to receive the weight of the rotatable opening and closing unit.

According to another embodiment of the present invention, the first body member (provided in the refrigerator having the hinge assembly) includes: a first protruding portion protruding from a rear surface of the first body member and seated in the body unit; and a first recessed portion recessed backward at a center of the first body member to receive first sides of the first and second support members to be inserted therein, and where the second body member includes: a second protruding portion protruding from a rear surface of the second body member and seated in the rotatable opening and closing unit; and a second recessed portion recessed backward at a center of the second body member to receive second sides of the first and second support members to be inserted therein.

According to another embodiment of the present invention, a plurality of the first and second support members are provided in the refrigerator having the hinge assembly and are inserted in the first and second recessed portions.

According to another embodiment of the present invention, a vertical length of each of the first and second recessed portions (provided in the refrigerator having the hinge assembly) is equal to a sum of a total height of the first and second protruding portions inserted therein.

According to another embodiment of the present invention, the first and second support members inserted in the first and second recessed portions provided in the refrigerator (having the hinge assembly) are arranged such that same support members are prevented from being layered continuously.

According to another embodiment of the present invention, the first body member (provided in the refrigerator having the hinge assembly) further includes a first guide groove recessed in a lower surface of the first recessed portion by a predetermined depth along a lateral direction, where the second body member further includes a second guide groove recessed in a lower surface of the second recessed portion by a predetermined depth along a lateral direction, where the first support member includes a first guide shaft-coupling hole formed therethrough with a side thereof disposed on the first guide groove to receive a guide shaft member moving along an extension direction of the first guide groove to be inserted therein, and where the second support member includes a second guide shaft-coupling hole formed therethrough with a side thereof disposed on the second guide groove to receive a guide shaft member moving along an extension direction of the second guide groove to be inserted therein.

According to another embodiment of the present invention, at an end of the first guide groove adjacent to the second support member and an end of the second guide groove adjacent to the first support member (provided in the refrigerator having the hinge assembly), steps are provided upwardly to restrict guide movement of first and second guide shafts.

According to another embodiment of the present invention, a radius of curvature of each of the steps (provided in the refrigerator having the hinge assembly) is equal to a radius of curvature of the cylindrical guide shaft member.

According to another embodiment of the present invention, each of the first and second guide grooves (provided in the refrigerator having the hinge assembly) is configured such that the first end provided with the step and a second end opposite to the first end are open, and the first support member is configured such that an extension length from a center to an end disposed on the first guide groove is shorter than or equal to an extension length of the first guide groove.

According to another embodiment of the present invention, the first support member (provided in the refrigerator having the hinge assembly) includes a first coupling shaft-coupling hole formed vertically through a center thereof, and the second support member includes a second coupling shaft-coupling hole formed vertically through a center thereof to receive a coupling shaft member to be inserted therein after being matched with the first coupling shaft-coupling hole, thereby being coupled to the first support member.

According to another embodiment of the present invention, the first body member (provided in the refrigerator having the hinge assembly) further includes first coupling means-insertion holes formed horizontally through upper and lower portions thereof respectively to receive coupling means to be inserted therein, and where the first protruding portion is disposed between a lowermost portion of an inner circumferential surface of the upper first coupling means-insertion hole and an uppermost portion of an inner circumferential surface of the lower first coupling means-insertion hole.

According to another embodiment of the present invention, a rear surface of the first support member (provided in the refrigerator having the hinge assembly) is shaped to prevent contact with the first body member during rotation of the rotatable opening and closing unit, and a rear surface of the second support member is shaped to prevent contact with the second body member during rotation of the rotatable opening and closing unit.

According to another embodiment of the present invention, the first protruding portion (provided in the refrigerator having the hinge assembly) includes a first locking shaft-insertion hole recessed from an upper surface thereof, the second support member including a second locking shaft-coupling hole formed through a second side thereof such that a second end thereof is coupled to the first body member by insertion of a locking shaft member after being aligned with the first locking shaft-insertion hole, where the second protruding portion includes a second locking shaft-insertion hole recessed downwardly from an upper surface thereof, and where the first support member includes a first locking shaft-coupling hole formed through a second side thereof such that a second end thereof is coupled to the second body member insertion of a locking shaft member after being aligned with the second locking shaft-insertion hole.

According to another embodiment of the present invention, the first recessed portion (provided in the refrigerator having the hinge assembly) includes a first body member-seat surface recessed inwardly from an inner surface thereof to receive a second end of the second body member to be partially inserted therein, and where the second recessed portion includes a second body member-seat surface recessed inwardly from an inner surface thereof to receive a second end of the first body member to be partially inserted therein.

According to another embodiment of the present invention, a refrigerator having a hinge assembly includes: a body unit forming an overall appearance of the refrigerator and being configured such that an inner space thereof is recessed from a front side to a rear side to form a storage compartment; a rotatable opening and closing unit coupled to the front side of the body unit to selectively and rotatably open and close the storage compartment; and a hinge assembly having a first side thereof coupled to the body unit and a second side thereof coupled to the rotatable opening and closing unit, the hinge assembly operable to allow the rotatable opening and closing unit to rotate, wherein the hinge assembly includes: a first body member extending in a vertical direction and being fixed to an inner surface of the body unit; a second body member extending in the vertical direction and being fixed to an inner surface of the rotatable opening and closing unit; a first support member configured such that a first end thereof is locked to the second body member and a second end thereof slidably moves along a first side of the first body member; and where a second support member is configured such that a first end thereof is locked to the first body member and a second end thereof slidably moves along a first side of the second body member.

According to another embodiment of the present invention, the first and second body members (provided in the refrigerator having the hinge assembly) include first and second coupling shaft-coupling holes formed vertically through centers thereof, and where coupling shaft members are inserted in the first and second coupling shaft-coupling holes such that the first and second body members are coupled to each other in a vertical direction.

Another embodiment of the present invention includes a refrigerator appliance comprising: a body comprising a recessed inner space forming a storage compartment; a rotatable door hinged to the body and configured to selectively open and close the storage compartment; and a hinge assembly having a first side thereof coupled to the body and having a second side thereof coupled to the rotatable door, wherein the hinge assembly is configured to allow the door to rotate, wherein the hinge assembly comprises: a first body member extending in a vertical direction and fixed to an inner surface of the body; a second body member extending in the vertical direction and fixed to an inner surface of the rotatable door; and first and second support members coupled to the first and second body members respectively, and further configured to receive a load of the rotatable door.

According to the above-described configuration, the embodiments of the present invention have the following effects.

The present invention is advantageous in that the entire thickness of the hinge assembly that guides rotation of the rotatable opening and closing unit is increased, thereby improving resistance to a vertical load caused by the weight of the rotatable opening and closing unit.

The present invention is further advantageous in that by improving the vertical load resistance of the hinge assembly to prevent deflection of the rotatable opening and closing unit, it is possible to improve the sealing force of the refrigerator.

The present invention is further advantageous in that the hinge assembly is disposed on the inner surface of the refrigerator without being coupled to the front and the rear surfaces of the rotatable opening and closing unit and the body unit and therefore does not protrude toward a user, thereby preventing possible injury accidents.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a reference view showing a refrigerator appliance to which a conventional hinge structure is coupled;

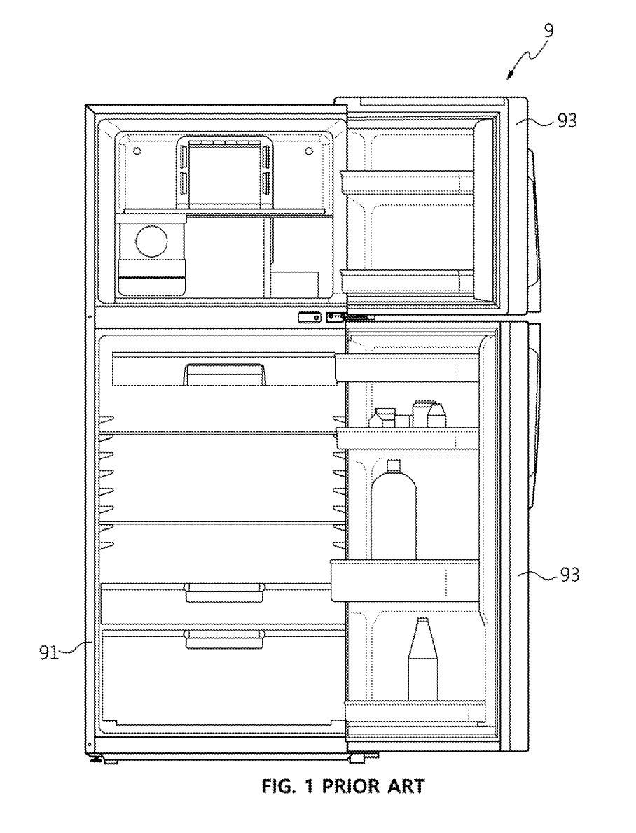

FIG. 2 is an enlarged view showing the hinge structure of FIG. 1;

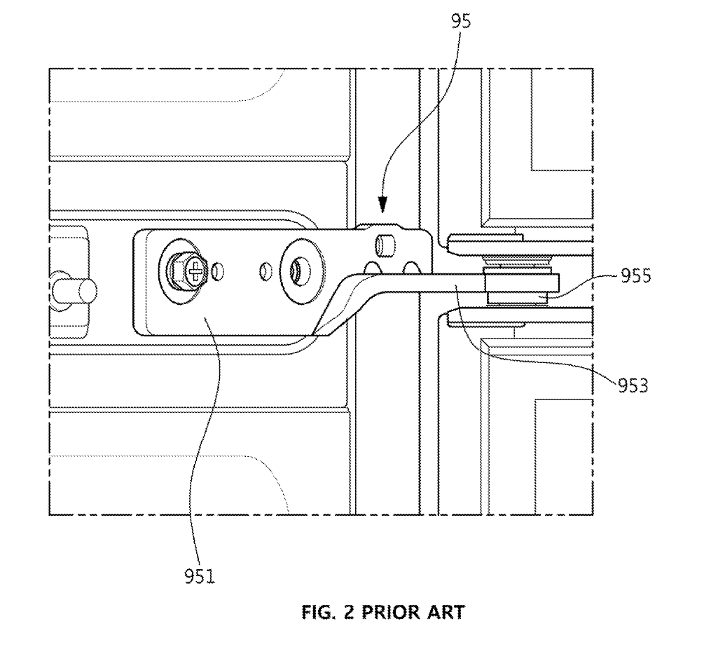

FIG. 3 is a reference view showing a refrigerator appliance having a hinge assembly according to an embodiment of the present invention;

FIG. 4 is a perspective view showing the hinge assembly according to an embodiment of the present invention;

FIG. 5 is an exploded perspective view of FIG. 3;

FIG. 6 is a reference view showing an operation of the hinge assembly when a rotatable opening and closing unit is closed in accordance with an embodiment of the present invention;

FIG. 7 is a reference view showing an operation of the hinge assembly when the rotatable opening and closing unit is opened in accordance with an embodiment of the present invention; and

FIGS. 8 and 9 are reference views showing a movement state of a guide shaft member configured to guide movement of first and second support members in accordance with an embodiment of the present invention.

### DETAILED DESCRIPTION OF THE INVENTION

The preferred embodiments of the present invention will be described in detail with reference to the accompanying drawings. These embodiments will be described in detail in order to allow those skilled in the art to practice the present invention. Wherever possible, the same reference numerals will be used throughout the drawings and the description to refer to the same or like elements or parts. Further, it is to be noted that, when the functions of conventional elements and the detailed description of elements related with the present invention may make the gist of the present invention unclear, a detailed description of those elements will be omitted.

Further, terms such as a first term and a second term may be used for explaining various constitutive elements, but the constitutive elements should not be limited to these terms. These terms is used only for the purpose for distinguishing a constitutive element from other constitutive element. For example, a first constitutive element may be referred as a second constitutive element, and the second constitutive element may be also referred to as the first constitutive element.

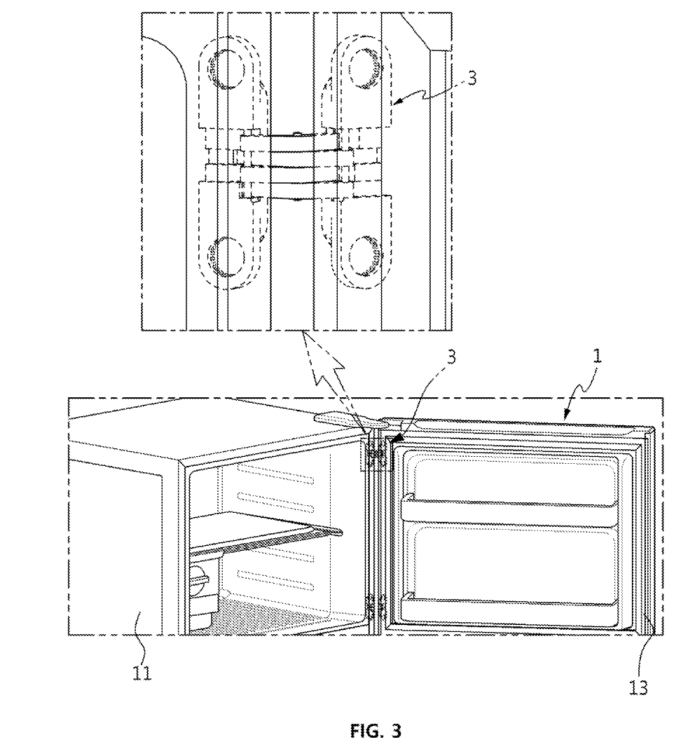

It is understood that the term “front surface” as used herein refers to the surface facing the user who is located on the outer surface of a rotatable opening and closing unit 13 from a refrigerator 1 (FIG. 3) and opens and closes the rotatable opening and closing unit 13, and the term “rear surface” refers to the surface facing the front surface away therefrom.

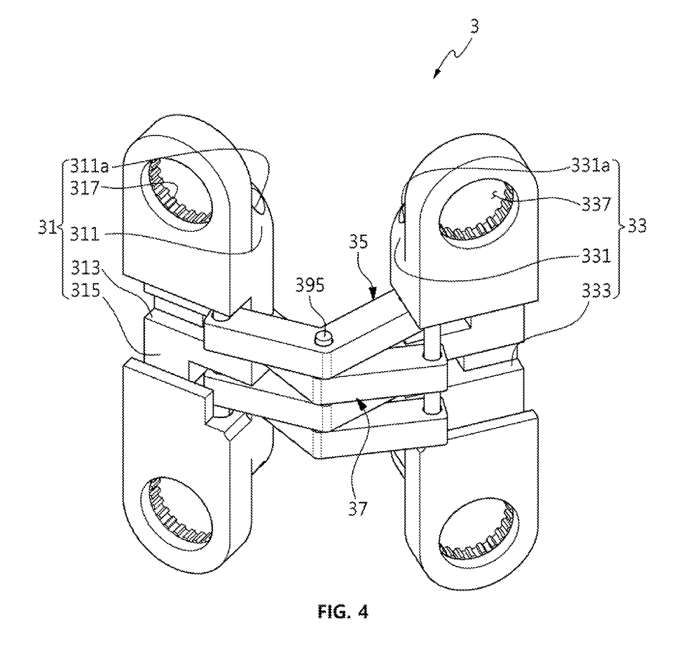

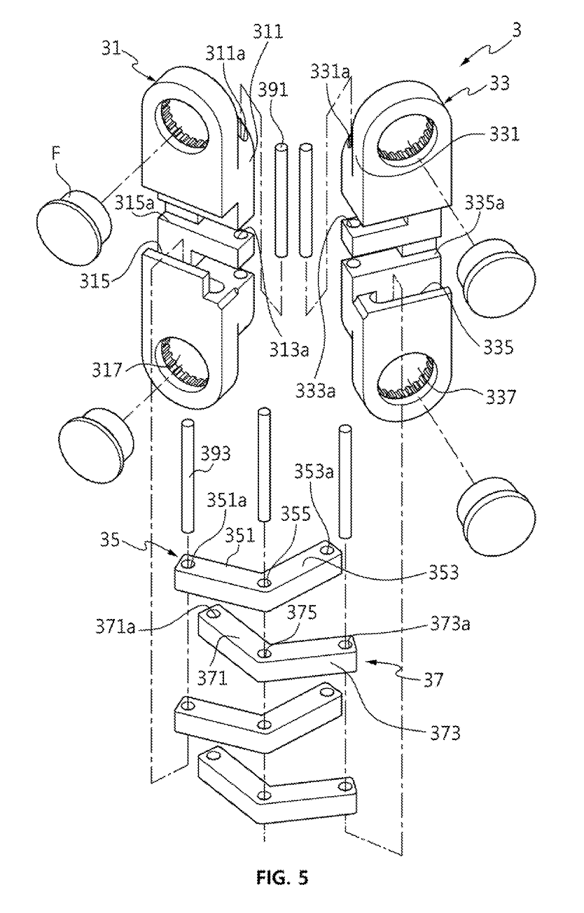

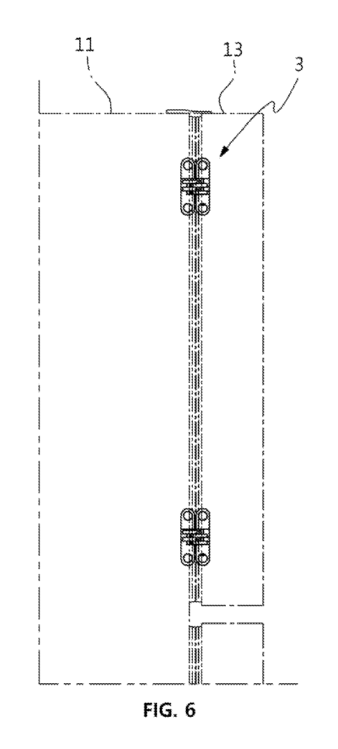

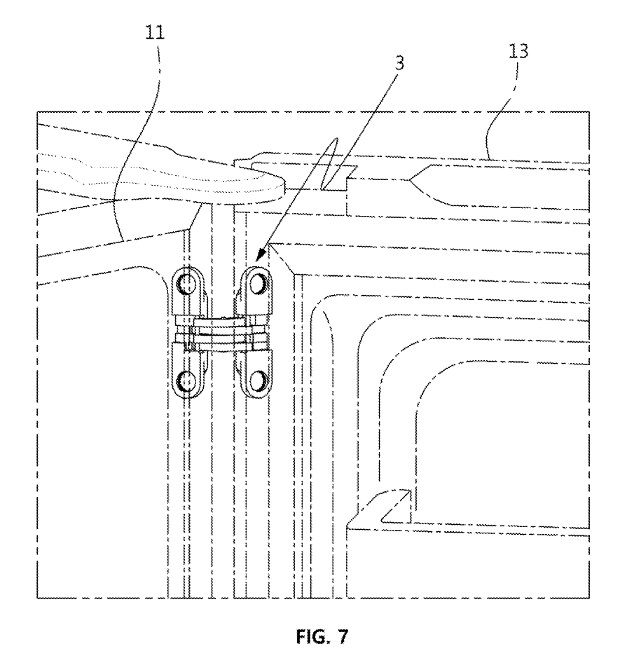

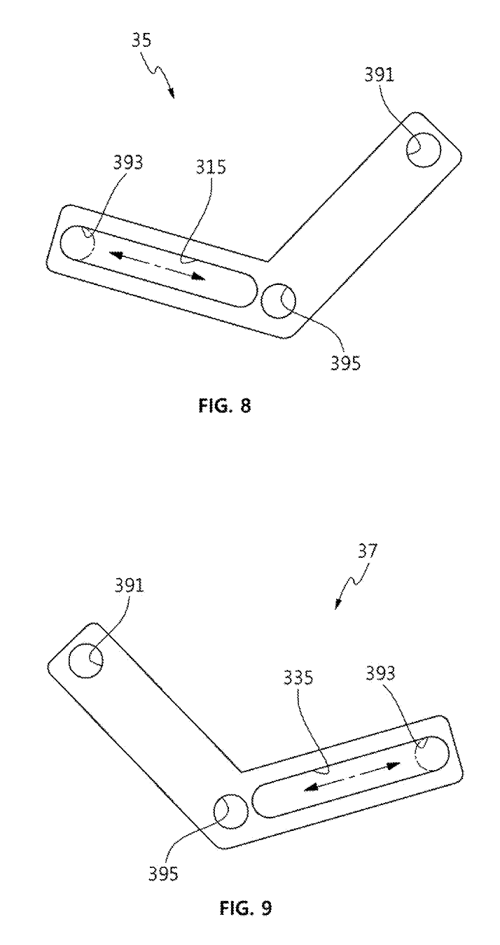

FIG. 3 is a reference view showing a refrigerator appliance having a hinge assembly according to an embodiment of the present invention; FIG. 4 is a perspective view showing the hinge assembly according to the embodiment of the present invention; FIG. 5 is an exploded perspective view of FIG. 3; FIG. 6 is a reference view showing an operation of the hinge assembly when a rotatable opening and closing unit is closed in accordance with an embodiment of the present invention; FIG. 7 is a reference view showing an operation of the hinge assembly when the rotatable opening and closing unit is opened in accordance with an embodiment of the present invention; and FIGS. 8 and 9 are reference views showing a movement state of a guide shaft member configured to guide movement of first and second support members in accordance with an embodiment of the present invention.

Reference will now be made to a hinge assembly and a refrigerator appliance having the same according to embodiments of the present invention with reference to the accompanying drawings.

Referring to FIG. 3, a refrigerator appliance 1 having a hinge assembly 3 according to an embodiment of the present invention includes: a body unit 11 forming an overall exterior appearance of the refrigerator and being configured such that an inner space thereof is recessed from a front side to a rear side, preferably being formed in a quadrangular (e.g., four sided) column shape, and forming a storage chamber (e.g., a refrigerating chamber or a freezing chamber, or both) for storing food therein; and a rotatable opening and closing unit 13 (e.g., door) coupled to a front side of the unit body unit 11 to selectively and rotatably open and close the internal space of the body unit 11. The rotatable opening and closing unit may be configured such that a rear surface thereof is recessed by a predetermined thickness to form an edge along an end portion thereof. For example, a quadrangular band shape is formed along the end portion on the rear surface of the quadrangular rotatable opening and closing unit 13.

Further, on the front side of the unit body unit 11 there may be one or more rotatable doors, each disposed on the left and right sides, or one rotatable door each on the upper and lower sides, but it should be noted that the scope of the present invention is not limited by these specific examples or any particular number of doors.

The refrigerator 1 according to an embodiment of the present invention further includes the hinge assembly 3 to allow the rotatable opening and closing unit 13 to be rotated from the body unit 11 in stable fashion, and hereinbelow, reference will be made in detail to the hinge assembly 3.

Referring to FIGS. 4 and 5, the hinge assembly 3 is coupled to the body unit 11 and the rotatable opening and closing unit 13 such that the refrigerator 1 can be selectively opened and closed by rotation of the rotatable opening and closing unit 13. For example, the hinge assembly 3 is configured such that a first side thereof is coupled to a first side of the body unit 11 and a second side thereof is coupled to a first side of the rotatable opening and closing unit 13.

As will be described in detail below, the hinge assembly 3 according to an embodiment of the present invention is configured such that the thickness thereof increases in the up and down direction compared to the conventional hinge structure, thereby significantly increasing the resistance to a continuous load in the downward direction, e.g., the weight of the door. Thus, in using the refrigerator 1, the lower deflection of the rotatable opening and closing unit 13 is minimized even with frequent opening and closing operations of the rotatable opening and closing unit 13. Therefore, it is possible to increase the sealing force and effectiveness of the refrigerator 1.

Further, one hinge assembly 3 may be provided in the body unit 11 and the individual rotatable opening and closing unit 13, or two hinge assemblies may be provided spaced apart from each other in the vertical direction, and three hinge assemblies may be provided as needed, but there is no limitation on the number of hinge assemblies that can be provided.

The hinge assembly 3 may include a first body member 31, a second body member 33, a first support member 35, a second support member 37, and a shaft member 39.

The first body member 31 extends in a vertical direction by a predetermined length and is fixed to a side of the body unit 11 of the refrigerator 1. Further, the first body member 31 may include a first protruding portion 311, a first recessed portion 313, a first guide groove 315, and a first coupling means-insertion hole 317 as described further below.

The first protruding portion 311 protrudes from a rear surface of the first body member 31 by a predetermined length and is seated on the body unit 11. Further, it is preferable that the first protruding portion 311 protrude between a lowermost portion of an outer circumferential surface of the first coupling means-insertion hole 317 formed at an upper portion of the first body member 31 and an uppermost portion of an outer circumferential surface of the first coupling means-insertion hole 317 formed at a lower portion of the first body member 31. Thus, it is possible to prevent mutual interference between the coupling means F, a pair of which passes through the first coupling means-insertion hole 317 substantially in the horizontal direction, and the locking shaft member 391 inserted into the first protruding portion 311 substantially in the vertical direction.

The first protruding portion 311 is disposed in the upper surface thereof with a first locking shaft-insertion hole 311a recessed downward by a predetermined depth to allow the locking shaft member 391 to be inserted thereinto. As will be described in detail below, after aligning the positions of the first locking shaft-insertion hole 311a and a second locking shaft-coupling hole 373a of the second support member 37, the locking shaft member 391 is inserted, whereby the second support member 37 is coupled with the first body member 31. This allows a first end of the second support member 37 to be locked to the first body member 31 such that a second end thereof is guided by a second guide groove 335.

The first recessed portion 313 is recessed from the center of the first body member 31 by a predetermined depth to allow first sides of first and second support members 35 and 37 to be inserted therein. In one embodiment, a vertical length of the first recessed portion 313 is substantially equal to the sum of a total height of the first and second support members 35 and 37. Accordingly, when one first and one second support members 35 and 37 are provided, the vertical length is substantially equal to the total height of two support members, and when two first and two second support members 35 and 37 are provided, the vertical length is substantially equal to the total height of four support members. For matching or aligning the second locking shaft-coupling hole 373a and the first locking shaft-insertion hole 311a with each other to receive the locking shaft member 391 to be inserted, the first recessed portion 313 of the first body member 31 is provided with a first body member-seat surface 313a recessed inwardly from an inner surface thereof by a predetermined depth. It is preferable that the depth of the first body member-seat surface 313a is substantially equal to the thickness of the second body member 33.

The first guide groove 315 is formed recessed in a lower surface of the first recessed portion 313 by a predetermined depth. Inside the first guide groove 315, a lower end of the guide shaft member 393 is inserted to guide movement of the first support member 35 when opening and closing the rotatable opening and closing unit 13. Further, the distance between opposite inner surfaces of the first guide groove 315 is substantially equal to a diameter of the guide shaft member 393, such that the shaft member 393 is restricted from separating from the first guide groove 315 or from shaking therein. This is also applied to the second guide groove 335.

Further, a step 315a is provided at the first end of the first guide groove 315, specifically at the side end adjacent to the second support member 37, where the step 315a is provided upwardly to restrict guide movement of the guide shaft member 393, thereby securing stable use of the hinge assembly 3. Further, it is preferable that the outer surface of the step 315a is shaped with the same curvature as the cylindrical guide shaft member 393 in order to minimize the left-right swing when the refrigerator is fully opened. Further, the second end of the first guide groove 315 may be open without being provided with a separate step, or may be provided with a step, but there is no limitation on this configuration.

The first coupling means-insertion hole 317 is formed horizontally through upper and lower portions of the first body member 31 respectively to receive the coupling means F to be inserted therein, whereby the first body member 31 is coupled to the body unit 11. The coupling means F may be of any of a variety of well known configurations that are suitable to allow the coupling of the body unit 11 and the first body member 31, and for example, may be a coupling screw. However, it should be noted that the scope of the present invention is not limited by these specific examples.

The second body member 33 extends in a vertical direction by a predetermined length and is fixed to the rotatable opening and closing unit 13. Further, the second body member 33 may include a second protruding portion 331, a second recessed portion 333, a second guide groove 335, and a second coupling means-insertion hole 337. The second body member 33 described below is shaped to have the same shape as the first body member 31 and includes the same configuration. However, for the sake of clarity, the configuration of the second body member 33 will be described in detail.

The second protruding portion 331 protrudes from a rear surface of the second body member 33 by a predetermined length and is seated on the first side of the rotatable opening and closing unit 13. Further, it is preferable that the second protruding portion 331 protrudes between a lowermost portion of an outer circumferential surface of the second coupling means-insertion hole 337 formed at an upper portion of the second body member 33 and an uppermost portion of an outer circumferential surface of the second coupling means-insertion hole 337 formed at a lower portion of the second body member 33. Thus, it is possible to prevent the mutual interference between the coupling means F, a pair of which passes through the second coupling means-insertion hole 337, 317 substantially in the horizontal direction, and the locking shaft member 391 inserted into the second protruding portion 331 substantially in the vertical direction.

The second protruding portion 331 is provided in the upper surface thereof with a second locking shaft-insertion hole 331a recessed downward by a predetermined depth to receive the locking shaft member 391 to be inserted thereinto. As will be described in detail below, after aligning the positions of the second locking shaft-insertion hole 331a and a first locking shaft-coupling hole 353a of the first support member 35, the locking shaft member 391 is inserted, whereby the first support member 35 is coupled with the second body member 33. This allows a first end of the first support member 35 to be locked to the second body member 33 such that a second end thereof is guided by the first guide groove 315 to be described later.

The second recessed portion 333 is recessed from the center of the second body member 33 by a predetermined depth to receive first sides of first and second support members 35 and 37 to be inserted therein. A vertical length of the second recessed portion 333 is substantially equal to the sum of a total height of the first and second support members 35 and 37. Accordingly, when one first and one second support members 35 and 37 are provided, the vertical length is substantially equal to the total height of two support members, and when two first and two second support members 35 and 37 are provided, the vertical length is substantially equal to the total height of four support members. Further, for matching (aligning) the first locking shaft-coupling hole 353a and the second locking shaft-insertion hole 331a with each other to allow the locking shaft member 391 to be inserted, the second recessed portion 333 of the second body member 33 is provided with a second body member-seat surface 333a recessed inwardly from an inner surface thereof by a predetermined depth. It is preferable that the depth of the second body member-seat surface 333a is substantially equal to the thickness of the first body member 31.

The second guide groove 335 is formed recessed in a lower surface of the second recessed portion 333 by a predetermined depth. Inside the second guide groove 335, a lower end of the guide shaft member 393 is inserted to guide movement of the second support member 37 when opening and closing the rotatable opening and closing unit 13.

Further, at the first end of the second guide groove 335, specifically at the side end adjacent to the first support member 35, the step 315a is provided upwardly to restrict guide movement of the guide shaft member 393, thereby securing stable use of the hinge assembly 3. Further, it is preferable that the outer surface of the step 315a is shaped with the same curvature as the cylindrical guide shaft member 393 in order to minimize the left-right swing when the refrigerator is fully opened. Further, the second end of the second guide groove 335 is open without being provided with a separate step.

The second coupling means-insertion hole 337 is formed horizontally through upper and lower portions of the second body member 33 respectively to allow the coupling means F to be inserted therein, whereby the second body member 33 is coupled to the rotatable opening and closing unit 13. The coupling means F may be of any of a variety of well known configurations that is sufficient to allow the coupling of the rotatable opening and closing unit 13 and the second body member 33, and for example, may be a coupling screw. However, it should be noted that the scope of the present invention is not limited by the specific examples of the coupling means, F.

The first support member 35 is coupled to the first and second body members 31 and 33 such that the body members 31 and 33 are rotatable. The first end side of the first support member 35 may be coupled to the first body member 31, and the second end side thereof may be coupled to the second body member 33. More preferably, the first end side of the first support member 35 is inserted into the first recessed portion 313 to be coupled to the first body member 31, and the second end side thereof is inserted into the second recessed portion 333 to be coupled to the second body member 33. The first support member 35 is configured such that the second end thereof slides along the first guide groove 315 while the first end thereof is fixed to the second body member.

In the drawings, two first support members 35 and two second support members 37 are layered, but the number of the first support members 35 and the second support members 37 is arbitrary, and it is preferable that a plurality of first support members 35 and second support members 37 are formed in accordance with embodiments of the present invention. Further, it is preferable that the first support members 35 and the second support members 37 are arranged such that the same members are not layered continuously in consideration of the stability of the entire assembly structure. Placing the same members not to be layered continuously means, in accordance with one embodiment, that the first support member 35 is not placed right on top of the first support member 35 and the second support member 37 is not placed right on top of the second support member 37.

The first support member 35 may include: a first guide extension portion 351 extending from the center thereof in a first direction to be disposed at the upper portion of the first guide groove 315; and may include a first fixed extension portion 353 extending in a second direction to be fixed to the second support member 37. Further, the first support member 35 may be formed in a V shape as a whole when viewed from above. The rear surface of the first support member 35 is shaped such that it prevents contact with the first body member 31 during rotation of the rotatable opening and closing unit 13, thereby preventing the mutual interference with the first body member 31.

The first support member 35 may be provided with a first coupling shaft-coupling hole 355 formed vertically through a center thereof. Thus, a coupling shaft member 395 is inserted into the inner spaced formed inside such that the first support member 35 and the second support member 37 are coupled to each other.

Further, it is preferable that the first guide extension portion 351 is configured such that the extension length from the center to the end is substantially equal to or shorter than the extension length of the first guide groove 315 to prevent an injury accident that may occur when the end portion thereof protrudes outside the first body member 31.

The first guide extension portion 351 is provided with a first guide shaft-coupling hole 351a formed vertically through the end thereof to receive the guide shaft member 393 to be inserted therethrough. The diameter of the first guide shaft-coupling hole 351a is substantially equal to that of the guide shaft member 393.

The first fixed extension portion 353 is configured such that the end thereof is fixed to the side of the second body member 35 to not allow guide movement. To achieve this, the first fixed extension portion 353 is provided with the first locking shaft-coupling hole 353a formed vertically through the end thereof to receive the locking shaft member 391 to be inserted therethrough. Thus, after matching the first locking shaft-coupling hole 353a and the second locking shaft-insertion hole 331a with each other, the locking shaft member 391 is inserted, whereby the first support member 35 and the second body member 33 are coupled to each other.

The second support member 37 is coupled to the first and second body members 31 and 33 such that the body members 31 and 33 are rotatable. The first end side of the second support member 37 may be coupled to the second body member 33, and the second end side thereof may be coupled to the first body member 31. More preferably, the first end side of the second support member 37 is inserted into the second recessed portion 333 to be coupled to the second body member 33, and the second end side thereof is inserted into the first recessed portion 313 to be coupled to the first body member 31. The second support member 37 is configured such that the second end thereof slides along the second guide groove 335 while the first end thereof is fixed to the first body member.

The second support member 37 may include: a second guide extension portion 371 extending from the center thereof in a first direction to be disposed at the upper portion of the second guide groove 335; and a second fixed extension portion 373 extending in a second direction to be fixed to the first support member 35. Further, similar to the first support member 35, the second support member 37 may be formed in a V shape as a whole when viewed from above. The rear surface of the second support member 37 is shaped such that it prevents contact with the second body member 33 during rotation of the rotatable opening and closing unit 13, thereby preventing the mutual interference with the second body member 33.

The second support member 37 may be provided with a second coupling shaft-coupling hole 375 formed vertically through a center thereof. Thus, a coupling shaft member 395 is inserted into the inner spaced formed inside such that the first support member 35 and the second support member 37 are coupled to each other.

Further, it is preferable that the second guide extension portion 371 is configured such that the extension length from the center to the end is substantially equal to or shorter than the extension length of the second guide groove 335 to prevent an injury accident that may occur when the end portion thereof protrudes outside the second body member 33.

The second guide extension portion 371 is provided with a second guide shaft-coupling hole 371a formed vertically through the end thereof to receive the guide shaft member 393 to be inserted therethrough. The diameter of the second guide shaft-coupling hole 371a is substantially equal to that of the guide shaft member 393.

The second fixed extension portion 373 is configured such that the end thereof is fixed to the side of the first body member 35 to not allow guide movement. To achieve this, the second fixed extension portion 373 is provided with the second locking shaft-coupling hole 373a formed vertically through the end thereof to receive the locking shaft member 391 to be inserted therethrough. Thus, after aligning the second locking shaft-coupling hole 373a and the first locking shaft-insertion hole 311a with each other, the locking shaft member 391 is inserted, whereby the second support member 37 and the first body member 31 are coupled to each other.

Hereinbelow, reference will be made in detail to the opening and closing operation of the refrigerator 1 having the hinge assembly 3 according to an embodiment of the present invention.

Referring to FIG. 6, firstly, when the refrigerator 1 is closed, that is, when the rotatable opening and closing unit 13 is in close contact with the front of the body unit 11, the first body member 31 and the second body member 33 are located side by side, and specifically, the front faces of the first and second body members 31 and 33 form an angle of 180 degrees with respect to each other. Then, referring to FIG. 7, when the refrigerator 1 is opened, e.g., by pulling the rotatable opening and closing unit 13 toward the user, in the state where the first end of the first support member 35 is fixed to the second body member 33, the second end thereof is guidingly moved from the open end of the first guide groove 315 to the first step 315a. Here, also in the state where the first end of the second support member 37 is fixed to the first body member 31, the second end thereof is guidingly moved from the open end of the second guide groove 335 to the second step 335a. Further, during this movement, the coupling shaft member 395 serves as the central axis of the hinge assembly 3 (see FIGS. 8 and 9).

As described above, by applying the hinge assembly 3 structure according to an embodiment of the present invention to the refrigerator 1, the entire thickness of the hinge structure is increased. In particular, when the refrigerator 1 is opened, the deflection of the rotatable opening and closing unit 13 can be minimized, by action of the hinge assembly 3, even in view of the continuous load according to the weight of the opening and closing unit 13. Therefore, it is possible to guarantee a sealing force above a predetermined level even in long-term use of the refrigerator 1.

Further, unlike the prior art, one side of the hinge assembly 3 is disposed on the inner surface of the refrigerator 1 without being coupled to the front surface of the body unit 11 of the refrigerator 1, thereby preventing potential injury accidents.

Although the preferred embodiment of the present invention has been disclosed for illustrative purposes, those skilled in the art will appreciate that various modifications, additions and substitutions are possible, without departing from the scope and spirit of the invention as disclosed in the accompanying claims. It is thus well known to those skilled in that art that the present invention is not limited to the embodiment disclosed in the detailed description, and the patent right of the present invention should be defined by the scope and spirit of the invention as disclosed in the accompanying claims. Accordingly, it should be understood that the present invention includes various modifications, additions and substitutions without departing from the scope and spirit of the invention as disclosed in the accompanying claims.

What is claimed is:

1. A refrigerator appliance, comprising:
a body unit forming an overall appearance of the refrigerator and comprising an inner space thereof being recessed from a front side to a rear side to form a storage compartment;
a rotatable opening and closing unit coupled to the front side of the body unit and configured to selectively open and close the storage compartment; and
a hinge assembly having a first side thereof coupled to the body unit and a second side thereof coupled to the rotatable opening and closing unit, wherein the hinge assembly is to configured to allow the rotatable opening and closing unit to rotate,
wherein the hinge assembly comprises:
a first body member extending in a vertical direction and fixed to an inner surface of the body unit;
a second body member extending in the vertical direction and fixed to an inner surface of the rotatable opening and closing unit; and
first and second support members coupled to the first and second body members respectively, and further configured to receive a load of the rotatable opening and closing unit.

2. The refrigerator appliance of claim 1, wherein the first body member comprises:
a first protruding portion configured to protrude from a rear surface of the first body member and seated in the body unit; and
a first recessed portion recessed backward at a center of the first body member and configured to receive first sides of the first and second support members inserted therein, and
wherein further the second body member comprises:
a second protruding portion configured to protrude from a rear surface of the second body member and seated in the rotatable opening and closing unit; and
a second recessed portion recessed backward at a center of the second body member and configured to receive second sides of the first and second support members inserted therein.

3. The refrigerator appliance of claim 2, further comprising a plurality of the first and second support members inserted in the first and second recessed portions.

4. The refrigerator appliance of claim 2, wherein a vertical length of each of the first and second recessed portions is equal to a sum of a total height of the first and second protruding portions inserted therein.

5. The refrigerator appliance of claim 2, wherein the first and second support members inserted in the first and second recessed portions are configured wherein same support members are not layered continuously.

6. The refrigerator appliance of claim 2, wherein the first body member further comprises a first guide groove recessed in a lower surface of the first recessed portion by a predetermined depth along a lateral direction,
wherein the second body member further comprises a second guide groove recessed in a lower surface of the second recessed portion by a predetermined depth along a lateral direction,
wherein the first support member comprises a first guide shaft-coupling hole formed therethrough with a side thereof disposed on the first guide groove to receive a guide shaft member moving along an extension direction of the first guide groove and inserted therein, and
wherein further the second support member comprises a second guide shaft-coupling hole formed therethrough with a side thereof disposed on the second guide groove to receive a guide shaft member moving along an extension direction of the second guide groove and inserted therein.

7. The refrigerator appliance of claim 6, comprising steps disposed at an end of the first guide groove adjacent to the second support member and at an end of the second guide groove adjacent to the first support member, wherein the steps are disposed upwardly to restrict guide movement of first and second guide shafts.

8. The refrigerator appliance of claim 7, wherein a radius of curvature of each of the steps is equal to a radius of curvature of the guide shaft member.

9. The refrigerator appliance of claim 7, wherein each of the first and second guide grooves is configured wherein the first end that is provided with the step, and a second end that is opposite to the first end, are both open, and wherein further
the first support member is configured wherein an extension length from a center to an end disposed on the first guide groove is shorter than or equal to an extension length of the first guide groove.

10. The refrigerator appliance of claim 2, wherein the first support member comprises a first coupling shaft-coupling hole aligned vertically through a center thereof, and wherein
the second support member comprises a second coupling shaft-coupling hole aligned vertically through a center thereof to receive a coupling shaft member inserted therein after aligning with the first coupling shaft-coupling hole, thereby being coupled to the first support member.

11. The refrigerator appliance of claim 2, wherein the first body member further comprises first coupling means-insertion holes aligned horizontally through upper and lower portions thereof respectively to receive coupling means inserted therein, and
wherein the first protruding portion is disposed between a lowermost portion of an inner circumferential surface of the upper first coupling means-insertion hole and an uppermost portion of an inner circumferential surface of the lower first coupling means-insertion hole.

12. The refrigerator appliance of claim 6, wherein a rear surface of the first support member is shaped to restrict contact with the first body member during rotation of the rotatable opening and closing unit, and
wherein a rear surface of the second support member is shaped to restrict contact with the second body member during rotation of the rotatable opening and closing unit.

13. The refrigerator appliance of claim 2, wherein the first protruding portion comprises a first locking shaft-insertion hole recessed from an upper surface thereof,
wherein the second support member comprises a second locking shaft-coupling hole formed through a second side thereof wherein a second end thereof is coupled to the first body member by insertion of a locking shaft member after aligning with the first locking shaft-insertion hole,
wherein the second protruding portion comprises a second locking shaft-insertion hole recessed downwardly from an upper surface thereof, and
wherein the first support member comprises a first locking shaft-coupling hole formed through a second side thereof wherein a second end thereof is coupled to the second body member by insertion of a locking shaft member after aligning with the second locking shaft-insertion hole.

14. The refrigerator appliance of claim 13, wherein the first recessed portion includes a first body member-seat surface recessed inwardly from an inner surface thereof to receive a second end of the second body member partially inserted therein, and wherein further
the second recessed portion includes a second body member-seat surface recessed inwardly from an inner surface thereof to receive a second end of the first body member partially inserted therein.

15. A refrigerator having a hinge assembly, the refrigerator comprising:
a body unit comprising a storage compartment;
a rotatable door coupled to a front side of the body unit to selectively open and close the storage compartment; and
a hinge assembly comprising: a first side coupled to the body unit; and a second side coupled to the rotatable door, the hinge assembly configured to allow the rotatable door to rotate,
wherein the hinge assembly further comprises:
a first body member extending in a vertical direction and fixed to an inner surface of the body unit;
a second body member extending in the vertical direction and fixed to an inner surface of the rotatable door;
a first support member having a first end locked to the second body member and having a second end thereof slidably movable along a first side of the first body member; and
a second support member having a first end thereof locked to the first body member and having a second end thereof slidably movable along a first side of the second body member.

16. The refrigerator of claim 15, wherein the first and second body members include first and second coupling shaft-coupling holes formed vertically through centers thereof, and wherein
coupling shaft members are inserted in the first and second coupling shaft-coupling holes wherein the first and second body members are coupled to each other in a vertical direction.

17. A refrigerator appliance comprising:
a body comprising a recessed inner space forming a storage compartment;
a rotatable door hinged to the body and configured to selectively open and close the storage compartment; and
a hinge assembly having a first side thereof coupled to the body and having a second side thereof coupled to the rotatable door, wherein the hinge assembly is configured to allow the door to rotate,
wherein the hinge assembly comprises:
a first body member extending in a vertical direction and fixed to an inner surface of the body;
a second body member extending in the vertical direction and fixed to an inner surface of the rotatable door; and
first and second support members coupled to the first and second body members respectively, and further configured to receive a load of the rotatable door.

18. The refrigerator of claim 17, wherein the first body member comprises:
a first protruding portion protruding from a rear surface of the first body member and seated in the body; and
a first recessed portion recessed backward at a center of the first body member and configured to receive first sides of the first and second support members inserted therein, and
wherein further the second body member comprises:
a second protruding portion protruding from a rear surface of the second body member and seated in the rotatable door; and
a second recessed portion recessed backward at a center of the second body member and configured to receive second sides of the first and second support members inserted therein.

19. The refrigerator of claim 18, further comprising a plurality of the first and second support members inserted in the first and second recessed portions.

20. The refrigerator of claim 18, wherein a vertical length of each of the first and second recessed portions is equal to a sum of a total height of the first and second protruding portions inserted therein.
